(19) United States
(12) Patent Application Publication
(10) Pub. No.: US 2013/0267159 A1
(43) Pub. Date: Oct. 10, 2013

(54) Air Extractors

(71) Applicant: Ford Global Technologies, LLC, Dearborn, MI (US)

(72) Inventors: Kevin Lee McCarthy, Milford, MI (US); Shiva Gumate, Canton, MI (US)

(73) Assignee: Ford Global Technologies, LLC, Dearborn, MI (US)

(21) Appl. No.: 13/903,607

(22) Filed: May 28, 2013

Related U.S. Application Data
(63) Continuation-in-part of application No. 12/293,363, filed on Feb. 10, 2009, now Pat. No. 8,207,623.

(51) Int. Cl. B60H 1/00

(52) U.S. Cl. CPC B60H 1/00457
USPC 454/162

(57) ABSTRACT

An air extractor assembly for an automotive vehicle is disclosed which has first and second air extractor valves mounted in a body panel. The first air extractor valve opens when pressure within the passenger compartment at a first pressure differential and the second air extractor valve opens at a second higher pressure differential. The second flap has a weight, which by virtue of gravity, resists opening. The weight can be a magnetic strip that is attracted to a ferrometallic and/or magnetic strip applied around the second aperture. By providing air extractor valves which open at different pressure differences, only the first air extractor valve opens when the pressure difference is in a lower range thereby limiting noise transmission into the passenger compartment. When a car door is shut and/or the climate control system is operating at maximum, the pressure difference is greater causing both extractor valves to open.

### CROSS-REFERENCE TO RELATED APPLICATIONS

This application is a continuation-in-part of U.S. application Ser. No. 12/293,363 filed Feb. 26, 2009, the disclosure of which is incorporated in its(their) entirety by reference herein.

### BACKGROUND

1. Field

The invention relates generally to air pressure equalization mechanisms, and more specifically to air extractor devices for use in automotive vehicle bodies.

2. Background Art

It is well known in the automotive vehicle body arts to provide a mechanism for equalizing the pressure between the interior compartment of the automobile and the atmosphere. To provide good heating and air conditioning in a vehicle, to protect the interior compartment of the vehicle from the elements and exhaust gases, and to restrict road and engine noise from the passenger compartment, the passenger compartment of the vehicle is substantially sealed from the atmosphere. During certain vehicle operating conditions, however, air pressure in the interior passenger compartment may exceed atmospheric pressure. This condition occurs routinely when the climate control blower is operating and/or when a vehicle door is moved from an open condition to a closed condition. If the interior is not vented to the atmosphere, the effort required to close the door may greatly increase, inconveniencing the person closing the door. Furthermore, a sudden, momentary increase in pressure in the cabin may be slightly uncomfortable to those within the passenger compartment.

Functional solutions to this problem are well known. They include the provision of a pressure-responsive device between the passenger compartment and the exterior of the vehicle, commonly referred to as an air extractor. Pressure equalization is provided by the air extractor when doors are closed and during demand for climate control when a blower is providing heating or cooling in the passenger compartment, as examples, by opening an air extractor valve which communicates between an interior and exterior of the vehicle to relieve the pressure. It is known that while the air extractor is open to allow pressure equalization, noise is transmitted from the exterior of the vehicle to the passenger compartment. The greater the cross-sectional opening of the air extractor, the more quickly the pressure is equalized; however, sound transmission into the passenger compartment is greater with a larger cross-sectional opening.

### SUMMARY

The inventors of the present invention have recognized that noise entering the vehicle through air extractors can be reduced in most operating conditions, thereby providing a quieter interior to the driver and passengers. The present invention would allow all valves to open only under either of two demanding conditions which occur less frequently (as compared with more frequent, steady-state operating conditions): door closing operation or climate control blower set to highest/maximum blower setting. Both door closing operation and maximum climate control blower setting are less-frequent or less-common operating conditions that typically cause greater pressure rise in the passenger compartment than low to medium blower control operation of the vehicle's climate control system (which are more-frequent or more-common operation conditions). The cross-sectional area of the air extractor is sized to provide appropriate pressure equalization for door closing, the most demanding and generally the least frequent operating condition. However, this provides a greater cross-sectional opening than needed when the climate control system's blower is operating on low or medium settings, and leads to higher transmission of exterior road noise into the interior passenger compartment than desired over an unnecessarily long period of time. In some applications, it may be desirable to have only one valve open when the climate control blower is operating at the maximum setting.

An air extractor system mounted in a body of an automotive vehicle is disclosed which has a first extractor valve which opens when pressure within a cabin of the vehicle exceeds atmospheric pressure by more than a first predetermined pressure and a second extractor valve which opens when cabin pressure exceeds atmospheric pressure by more than a second predetermined pressure. The second predetermined pressure is greater than the first predetermined pressure. In one embodiment, the first extractor valve is mounted in a first body panel, the second extractor valve is mounted in a second body panel, and both of the first and second body panels communicate with the atmosphere on one side and with the vehicle cabin on the other side. In another embodiment, the first extractor valve is fitted over a first aperture defined in the first body panel, the second extractor valve is fitted over a second aperture defined in the second body panel. The first and second apertures have substantially equal cross-sectional areas. The first extractor valve is urged toward a closed position by a first biasing force and the second extractor valve is urged toward a closed position by a second biasing force. The first biasing force is less than the second biasing force. In one embodiment, the second flap has an affixed weight. The first and second flaps are mounted with the hinge portion upward such that the mass of the flap causes the flaps to be in a closed position in the absence of a pressure difference. The weight of the second flap causes a greater biasing force to be applied to the second flap than the first flap. In one embodiment, the weight is a magnetic strip applied to the periphery of the second flap on the side of the second flap facing the aperture. The magnetic weight is attracted to a ferrometallic material in the frame of the extractor valve. The ferrometallic material can be due to the periphery of the second aperture being ferrometallic, or alternatively, can be from a strip applied to the periphery which is ferrometallic or magnetized. The magnetic force between the flap and the periphery of the ferrometallic material on the periphery of the aperture resists the opening of the second flap.

Alternatively, the first extractor valve is fitted over a first aperture defined in the first body panel and the second extractor valve is fitted over a second aperture defined in the second body panel. The first aperture has a smaller cross-sectional area than the second. The first extractor valve is urged toward a closed position by a first biasing force and the second extractor valve is urged toward a closed position by a second biasing force with the first biasing force is less than the second biasing force.

In another embodiment, the first extractor valve and the second extractor valve are mounted in an aperture defined in a single body panel and the first and second extractor valves are substantially flush mounted in the single body panel.

In one alternative, the first extractor valve has a first flap biased toward a closed position, the second extractor valve has a second flap biased toward a closed position, and the second flap has a flap magnetic strip applied to its periphery on a side of the second flap that meets with a frame of the air extractor assembly when in a closed position. A frame ferrometallic strip is applied to the frame of the air extractor assembly located to mate with the flap magnetic strip. The flap and frame strips provide resistance to opening the second extractor valve. Magnetic strip refers to a strip made of a magnetic material which is magnetized. Ferrometallic strip refers to a material which could be magnetized. In one alternative, the frame ferrometallic strip is not magnetized, but is attracted by a magnet, such as the flap magnetic strip. Alternatively, the frame ferrometallic strip is magnetized. In yet another alternative, the second flap has a frame magnetic strip applied to the frame of the air extractor and a flap ferrometallic strip applied to the periphery of the second flap located so that the frame magnetic strip and the flap metallic strip come together when the air extractor assembly is in a closed position. In one embodiment, the flap ferrometallic strip is not magnetized and in another embodiment, it is magnetized.

An air extractor assembly for an automotive vehicle is disclosed having a body with a passenger compartment formed by a plurality of body panels. The air extractor assembly has a first air extractor valve mounted in a body panel and a second air extractor valve mounted in the body panel. The first air extractor valve opens when pressure within the passenger compartment exceeds atmospheric pressure by more than a first predetermined pressure and the second air extractor valve opens when pressure within the passenger compartment exceeds atmospheric pressure by more than a second predetermined pressure. The second predetermined pressure is greater than a first predetermined pressure. A first flap coupled to the first air extractor valve is urged toward a closed position by a first biasing force and a second flap coupled to the second air extractor valve is urged toward a closed position by a second biasing force.

One embodiment further includes a flap magnetic strip affixed to the second flap at the periphery of the second flap on a side of the flap which abuts a frame of the air extractor assembly when the second extractor valve is in a closed position. The air extractor assembly may further include a frame magnetic strip affixed to the frame of the air extractor assembly; the frame magnetic strip is located such that the frame magnetic strip abuts the flap magnetic strip when the second extractor valve is in a closed position.

Also disclosed is an air extractor assembly mounted in a body panel of an automotive vehicle, having a first extractor valve which opens when pressure within a cabin of the vehicle exceeds atmospheric pressure by more than a first predetermined pressure and a second extractor valve which opens when cabin pressure exceeds atmospheric pressure by more than a second predetermined pressure, the second predetermined pressure is greater than a first predetermined pressure.

In one embodiment, the first and second extractor valves are fitted over first and second apertures defined in the body panel; the first and second apertures have substantially equal cross-sectional areas; the first extractor valve is urged toward a closed position by a first biasing force; the second extractor valve is urged toward a closed position by a second biasing force; the first biasing force is less than the second biasing force.

Alternatively, the first and second extractor valves are fitted over first and second apertures defined in the body panel; the first aperture has a smaller cross-sectional area than the second aperture; the first extractor valve is urged toward a closed position by a first biasing force; the second extractor valve is urged toward a closed position by a second biasing force; the first biasing force is less than the second biasing force. In one embodiment, the force acting on the flaps comes about by virtue of gravity acting on the flaps. The first flap has less mass and thus a lesser force acting upon it compared with the second flap. The second flap has a greater mass than the first flap due to one or more of the following: having a mass affixed, being made of a denser material, and being thicker.

An advantage of the present invention is that only one of the air extractor valves is open during normal, less-frequent, or less-common operation of the climate control system, i.e., blower settings less than maximum. Thus, the cross-sectional area allowing fluid communication and transmission of exterior noise into the passenger compartment is less than prior art systems in which all air extractor valves are open. The air extractor valve which opens only at a greater pressure difference is available to open when a larger pressure difference is experienced, which generally occurs less frequently, such as vehicle door closing or climate control blower set to maximum speed. At door closing, the vehicle is presumably not moving. Thus, exterior noise transmission into the passenger compartment is of little concern. But, during normal operation with a blower of the climate control system operating at a setting less than maximum and external road noise is a concern, only one of the air extractor valves is open normally. If the air extractor valve, which opens at the lower pressure differential is made smaller than the other air extractor valve, the noise level is reduced even further.

### BRIEF DESCRIPTION OF THE DRAWINGS

These and other advantages of the present invention will be apparent to those skilled in the art upon reading the following description with reference to the accompanying drawings, in which:

FIG. 1 is a partial perspective view of an automotive vehicle including an air extractor assembly;

FIGS. 2A-2C are partial perspective views of an air extractor assembly having two extractor valves installed in depressions in the body panel, with FIG. 2A having both valves closed, FIG. 2B having an upper valve open and a lower valve closed, and FIG. 2C having both valves open;

FIG. 2D is a partial perspective view of an air extractor assembly having two extractor valves having visibly different cross sectional areas;

FIG. 3 is a partial perspective view of an air extractor having two valves, one open and one closed in a configuration in which there the valves are mounted flush with the body panel; and

FIG. 4 is a partial perspective view of an automotive vehicle including air extractor assemblies in two separate body panels.

### DETAILED DESCRIPTION OF THE EMBODIMENT(S)

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

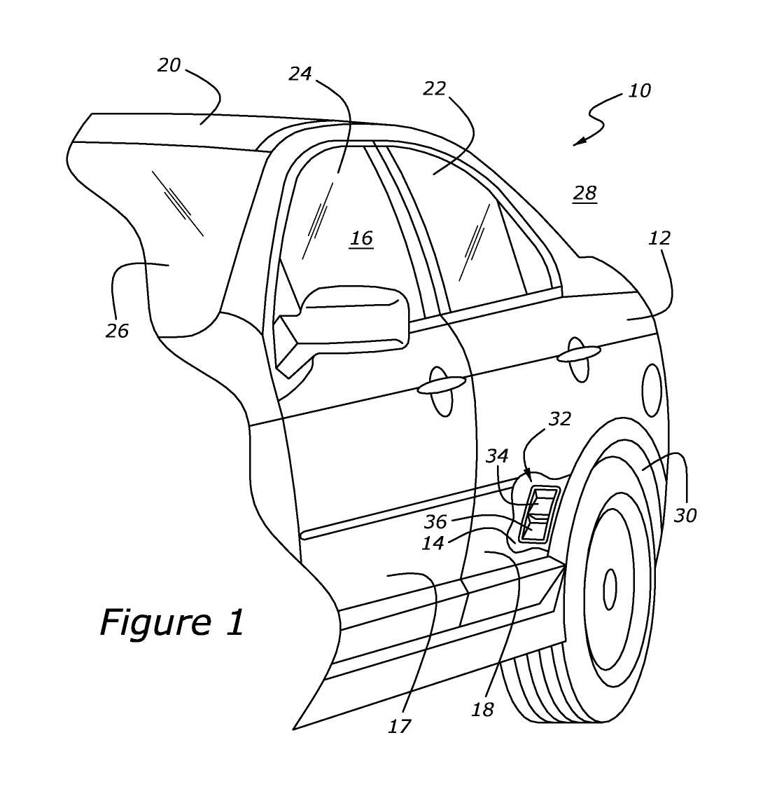

In FIG. 1, an automotive vehicle 10 includes a body 12. The body has surfaces enclosing a passenger compartment 16, the surfaces including: body panels, such as wheel well panel 14, doors 17 and 18, roof 20, and windows 22, 24, and 26. Besides the inevitable small leak paths, fluid communication between passenger compartment 16 and the atmosphere 28 is provided intentionally through the wheel well area 30 by air extractor assembly 32. FIG. 1 shows a view of the wheel well panel 14 from the perspective of the inside surface, i.e., the surface communicating with the passenger compartment. Two depressions 34 and 36 in wheel well panel 14 are shown.

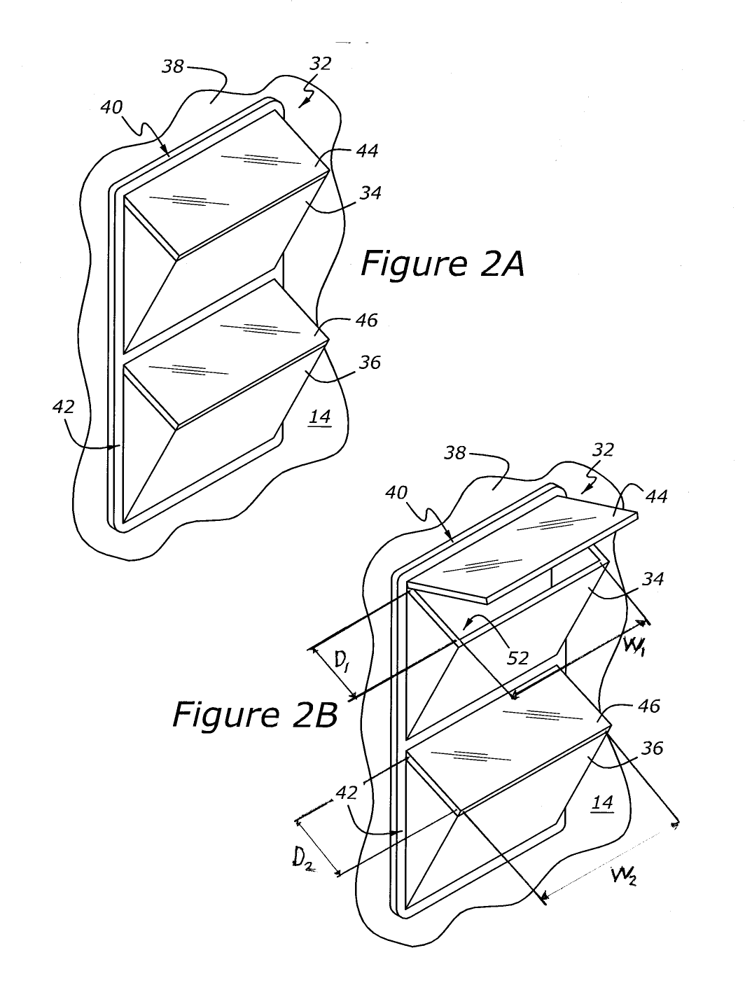

In FIGS. 2A-2C, wheel well panel 14 is shown from an exterior view, with depressions 34 and 36 jutting outward from wheel well panel 14. Air extractor valves 40 and 42 are secured to wheel well panel 14. If wheel well panel 14 is formed as a sheet metal stamping, air extractor valves 40 and 42 are attached to the wheel well panel 14 in any conventionally known manner, such as with pins or rivets, as non-limiting examples. An air extractor valve 40 permits fluid communication between passenger compartment 16 and the atmosphere 28 when air pressure within passenger compartment 16 exceeds pressure in the atmosphere 28 by a predetermined amount. When there is no pressure difference between passenger compartment 16 and the atmosphere 28, air extractor valve 40 is closed, thereby largely preventing transmission of noise and flow of air from the exterior of vehicle 10 into passenger compartment 16.

Air extractor valves 40 and 42, as illustrated in FIG. 2A, have flaps 44 and 46, respectively. Depressions 34 and 36 define apertures 52 and 54, respectively, such that flap 44 closes aperture 52 and flap 46 closes aperture 54 when normally closed. Flaps 44 and 46 substantially prevent fluid communication between passenger compartment 16 and atmosphere 28 when closed, as shown in FIG. 2A. To cause flaps 44 and 46 to close, a biasing force is applied. In one embodiment, gravity acting on the mass of flaps 44 and 46 cause them to close in the absence of a pressure differential. In one embodiment, the biasing force comes about by making the flap out of a resilient material, with flap 44 having a thinner cross-section of the resilient material in the area of where it hinges, or bends, than flap 46. The thicker material resists bending more, thus providing the greater biasing force to retain flap 46 in a closed position. In another embodiment, flaps 44 and 46 are hingedly connected to the frame of air extractor assembly 32. The biasing force is applied by a spring (not shown) on the hinged joint. These are non-limiting examples; any known device for providing a biasing force to cause such a valve to attain a closed position, in the absence of an opposing force, is also within the scope of the present invention.

In FIG. 2C, flaps 44 and 46 are both open, allowing fluid communication between passenger compartment 16 and atmosphere 28. The open area, in the condition shown in FIG. 2C is the sum of the cross-sections of apertures 52 and 54.

In FIG. 2B, flap 44 is open and flap 46 is closed. The biasing forces applied to flap 44 and 46 are such that flap 44 opens when a first predetermined pressure difference exists between passenger compartment 16 and atmosphere 28 and flap 46 opens when a second predetermined pressure difference exists between passenger compartment 16 and atmosphere 28, with the first predetermined pressure being less than the second predetermined pressure. Thus, the situation illustrated in FIG. 2B is one in which the pressure difference between passenger compartment 16 and atmosphere 28 is in between the first and second predetermined pressures.

As indicated in FIG. 2B, first aperture 52 may be substantially rectangular with a first dimension (or depth) D₁ and a second dimension (or width) W₁, and second aperture 54 may also be substantially rectangular with a first dimension (depth) D₂ and a second dimension (width) W₁. The dimensions D₁ and D₂ may be relatively close to being equal to one another, such that they may appear to be approximately equal to one another. Likewise, W₁ and W₂ may be relatively close to being equal to one another, such that they may appear to be approximately equal to one another. But relatively small deviations from these apparent dimensional equalities may be present which result in first and second apertures 52, 54 having different respective cross sectional areas. Such a difference in area between the first and second apertures 52, 54 may be utilized to design the air extractor valves 40, 42 such that they open at different levels of pressure difference between passenger compartment 16 and the atmosphere 28. Differences in the relative sizes and/or relative masses of flaps 44, 46 may also be used to contribute to the different designed opening pressure levels.

In the situation where the cross-sectional areas of apertures 52 and 54 are equal, the biasing force applied to flap 44 is less than the biasing force applied to flap 46. In the following table summarizing FIGS. 2A-2C, ΔP is the pressure difference between passenger compartment 16 and atmosphere 28 and open area refers to the opening area which flaps 44 and/or 46 uncover when they are in an open position.

| | Pressure | Flap | Flap | |
|---|---|---|---|---|
| Figure | difference, ΔP | 44 | 46 | Open area |
| 2A | ΔP ≦ P1 | Closed | Closed | None |
| 2B | P1 < ΔP ≦ P2 | Open | Closed | Area of aperture 52 |
| 2C | ΔP > P2 | Open | Open | Area of apertures 52 |
| | | | | and 54 |

In FIG. 2C, the situation in which both flaps 44 and 46 are open is shown. The direction of the acceleration of gravity with respect to the configuration of air extractor assembly 132 is shown in FIG. 2C. In one embodiment, it is the acceleration due to gravity that acts upon flaps 44 and 46 to bias them toward their closed position. The configuration shown in FIG. 2C is a non-limiting example.

FIG. 2D illustrates a further exemplary embodiment wherein the possible inequalities between dimensions D₁, D₂, W₁, and W₂ discussed above in relation to FIG. 2B are more clearly visible. First aperture 52 has a first or depth dimension that is visibly smaller than a corresponding first or depth dimension of second aperture 54, such that the relative cross-sectional areas of the first and second apertures 52, 54 are different. This difference in size between the first and second apertures 52, 54 may cause the air extractor valves 40, 42 to open at different levels of pressure difference between passenger compartment 16 and the atmosphere 28. Differences in the relative sizes and/or relative masses of flaps 44, 46 may also be used to contribute to the different opening pressure levels. The embodiment shown in FIG. 2D is a single, a non-limiting example of one of many different ways that one or more dimensions of air extractor valves and/or flaps may be varied to achieve a desired difference in opening pressure levels of separate air extractors.

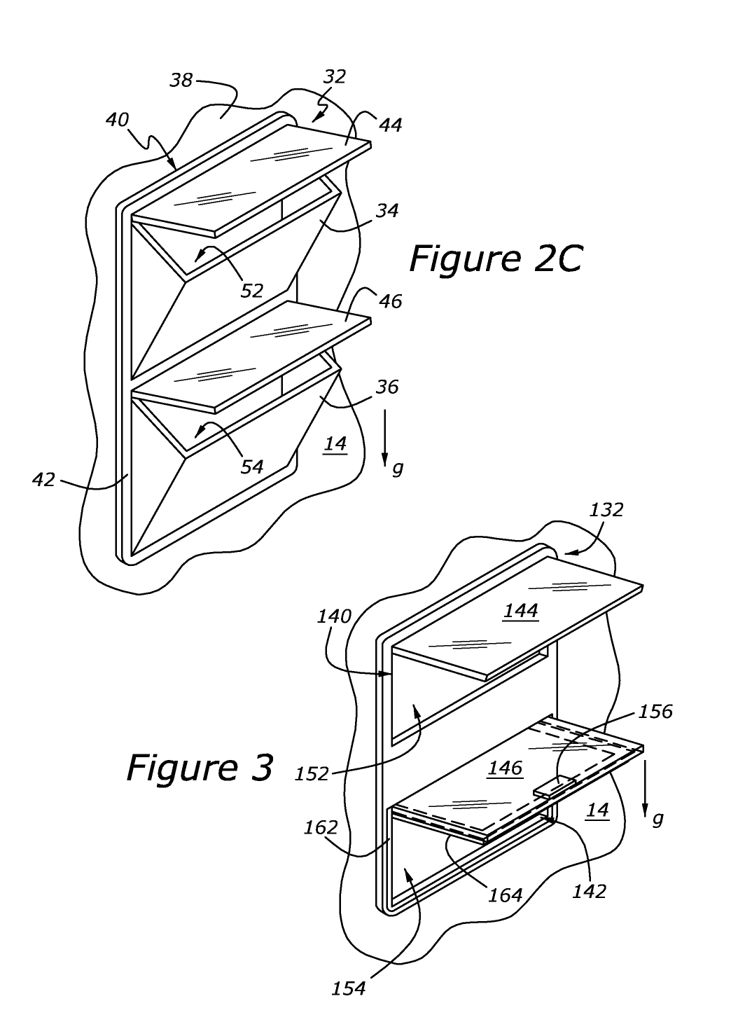

In FIG. 3, the air extractor assembly 132 is shown in a configuration in which there are no depressions in body panel 14. In the illustration of FIG. 3, the pressure difference is such that both extractor valves 140 and 142 are open, i.e., flaps 144 and 146 are uncovering apertures 152 and 154, respectively. There is at least one aperture defined in body panel 14 over which air extractor assembly 132 is mounted.

In one embodiment, the pressure difference at which flaps 144 and 146 open are different due to selection of the biasing force acting on flaps 144 and 146. In an alternative embodiment, a flexible magnetic strip 162 is applied to valve 142 around aperture 144 which mates with magnetic strip 164 applied to flap 146. If the frame around aperture 154 is made of a magnetic material, magnetic strip 164 is not required. Or, if flap 146 is made of a magnetic material, magnet strip 164 is not required. By using a magnetic strip, the pressure difference required to open valve 142 is greater than that to open valve 140, i.e., the type of pressure difference existing when there is a door closing. Furthermore, the magnetic strip, which would be made from a flexible material, can improve the seal of extractor valve 142, thereby lessening the noise transmission through extractor valve 142 when it is in a closed position.

As shown in FIG. 3, strips 162 and 164 on three edges of the opening. Alternatively, strips 162 and/or 164 can extend along one edge, two edges, a portion of one of the edges, any combination. In such an embodiment, a sealing strip might be provided in the portions of the edges not having a strip for sealing purposes.

In another embodiment, the biasing force is due to gravity acting on flaps 144 and 146. To provide a greater biasing force, flap 146 is provided with a weight 156. Flap 146 can be provided with both weight 156 and with a magnetic biasing force provided by strips 162 and 164, as discussed above.

Air extractor assembly 32 is shown mounted on a wheel well panel 14, as a non-limiting example in FIGS. 2A-2C. Air extractor assembly 32 can be mounted in any body panel which can provide fluid communication between passenger compartment 16 and the atmosphere 28. For example, in a pickup, air extractors can be mounted in between the box and the bed. In sedans, the air extractors can be mounted in the trunk surface abutting the back seats. FIGS. 2A-2C show two air extractor valves 40 and 42 of similar size mounted in the same body panel 14. Without departing from the scope of the invention, the air extractors are of different cross-sectional areas. The biasing force acting on flaps 44 and 46 are adjusted to reflect that they open at different pressure differences, keeping in mind that force is equal to pressure times area over which the pressure is acting. In another alternative, there are more than two air extractors with opening pressure differences at two or more predetermined pressures. In yet another alternative, air extractor valves 40 and 42 are mounted on two separate body panels.

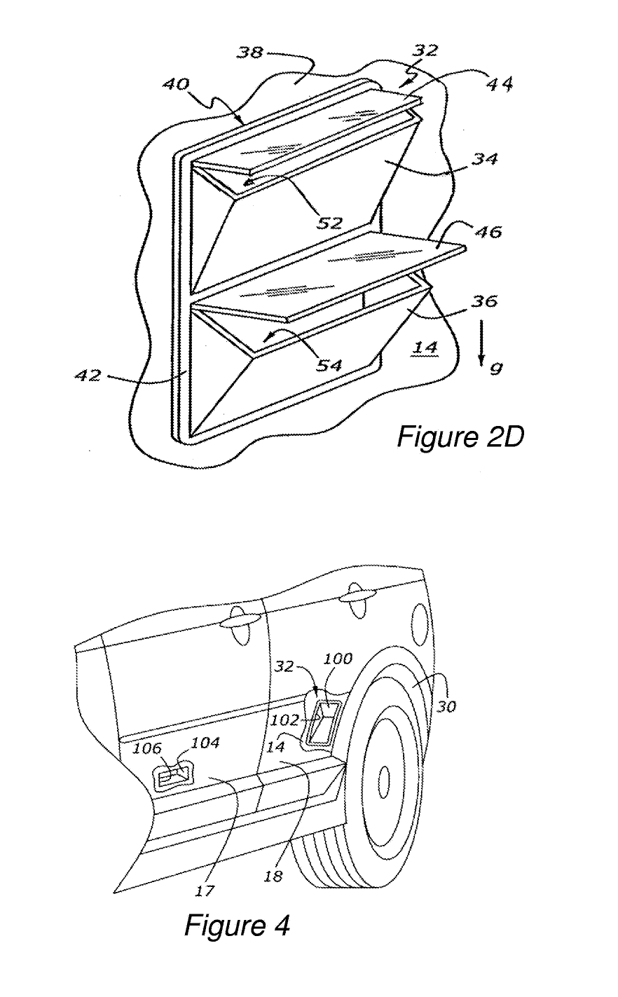

In an embodiment shown in FIG. 4, a first extractor valve 100 is fitted over a first aperture 102 defined in a first body panel 32 and a second extractor valve 104 is fitted over a second aperture 106 defined in a second body panel 17. The first aperture 102 may have a smaller cross-sectional area than the second aperture 106. The first extractor valve 100 is urged toward a closed position by a first biasing force and the second extractor valve 104 is urged toward a closed position by a second biasing force with the first biasing force is less than the second biasing force.

The embodiments shown in the Figures show two air extractor valves 40 and 42. However, it is contemplated that an air extractor assembly may have three or more extractor valves opening at two or more pressure differentials.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. An air extractor assembly mounted in a body panel of an automotive vehicle, comprising:
a first extractor valve having a first flap biased toward a closed position covering a first aperture defined within the body panel, the first aperture having a first cross-sectional area and the first flap opening when pressure within a cabin of the vehicle exceeds atmospheric pressure by more than a first predetermined pressure;
a second extractor valve having a second flap biased toward a closed position covering a second aperture defined within the body panel, the second aperture having a second cross-sectional area greater than the first cross-sectional area and the second flap opening when pressure within the cabin of the vehicle exceeds atmospheric pressure by more than a second predetermined pressure, the second predetermined pressure is greater than the first predetermined pressure.

2. The air extractor assembly of claim 1, further comprising:
a first depression formed in the body panel with the first extractor mounted in the first depression over the first aperture; and
a second depression formed in the body panel with the second extractor mounted in the second depression over the second aperture.

3. The air extractor assembly of claim 1, wherein the body panel into which the air extractor assembly is mounted forms a wheel well.

4. The air extractor assembly of claim 1, further comprising:
a flap magnetic strip applied to the second flap wherein the frame magnetic strip and the flap magnetic strip are positioned such that the magnetic force acting between the magnets resist opening of the second flap.

5. The air extractor assembly of claim 1, further comprising:
a ferrometallic flap strip applied to the second flap wherein the frame magnetic strip and the flap ferrometallic strip are positioned such that the magnetic force acting between the frame magnet strip and the ferrometallic flap strip resist opening of the second flap.

6. An air extractor assembly mountable in a body of an automotive vehicle to communicate between a vehicle cabin and an exterior of the vehicle, comprising:
a first extractor valve having a first flap mounted in a first aperture defined in the body, the first aperture having a first cross-sectional area whereby the first flap opens when pressure within the cabin exceeds atmospheric pressure by more than a first predetermined pressure;
a second extractor valve having a second flap adapted to cover a second aperture defined in the body, the second aperture having a second cross-sectional area greater than the first cross-sectional area whereby the second flap opens when pressure within the cabin exceeds atmospheric pressure by more than a second predetermined pressure, the second predetermined pressure is greater than the first predetermined pressure.

7. The air extractor assembly of claim 6 further comprising: a weight mounted on the second flap wherein the mass of the second flap is greater than the mass of the first flap.

8. The air extractor assembly of claim 6 further comprising: a weight mounted on the second flap.

9. The air extractor assembly of claim 6, further comprising: a flap magnetic strip applied to the periphery of the second flap on a side of the second flap that faces the second aperture.

10. The air extractor assembly of claim 9, further comprising: a frame ferrometallic strip applied to the frame of the air extractor assembly located to mate with the flap magnetic strip, wherein the flap and frame strips provide resistance to opening the second extractor valve.

11. The air extractor assembly of claim 10 wherein the frame ferrometallic strip is magnetized.

12. The air extractor assembly of claim 6 wherein the second flap is thicker than the first flap.

13. The air extractor assembly of claim 6 wherein the first flap has a first hinge and the second flap has a second hinge, the first hinge is mounted on the upper side of the first aperture and the second hinge is mounted on the upper side of the second aperture such that gravity acts upon the first and second flaps to cause them to be in a closed position in the absence of a pressure difference acting upon the first and second flaps.

14. The air extractor system of claim 6, wherein the first extractor valve is mounted in a first body panel, the second extractor valve is mounted in a second body panel, both of the first and second body panels communicate with the atmosphere on one side and with the vehicle cabin on the other side, the first flap opens when pressure within a cabin of the vehicle exceeds atmospheric pressure by more than a first predetermined pressure, the second flap opens when pressure in the cabin exceeds atmospheric pressure by more than a second predetermined pressure, and the second predetermined pressure exceeds the first predetermined pressure.
